(19) United States
(12) Patent Application Publication
(10) Pub. No.: US 2015/0021118 A1
(43) Pub. Date: Jan. 22, 2015

(54) Assistant Harness

(71) Applicant: Glen DOTY, Sacramento, CA (US)

(72) Inventor: Glen DOTY, Sacramento, CA (US)

(21) Appl. No.: 14/331,802

(22) Filed: Jul. 15, 2014

Related U.S. Application Data
(60) Provisional application No. 61/847,215, filed on Jul. 17, 2013.

(51) Int. Cl. A62B 35/00

(52) U.S. Cl. CPC A62B 35/0025
USPC 182/3

(57) ABSTRACT

An assistant harness is provided to help attendants such as caregivers and first responders move patients or victims in a supportive, safe, and dignified manner. The harness has a belt that wraps around a patient's waist, with a first end having a primary buckle and the second end being engaged with the primary buckle to create a loop. To allow patients to be carried, a first leg strap and a second leg strap are provided. When not needed the first and second leg strap are held out of the way by restraining straps. When needed to help lift a patient, the first leg strap and second leg strap can be engaged with corresponding buckles on the front of the belt, effectively creating a seat to support the patient. Handles are positioned on each side of the belt to help attendants assist a patient, including lifting the patient as necessary.

The current application claims a priority to the U.S. Provisional Patent application Ser. No. 61/847,215 filed on Jul. 17, 2013.

### FIELD OF THE INVENTION

The present invention relates generally to harnesses and safety equipment. More specifically, the present invention is a harness that allows users to ergonomically and safely lift, support, and maneuver a person.

### BACKGROUND OF THE INVENTION

First responders such as police officers, firefighters, and emergency medical services personnel are often tasked with assessing a situation and reacting accordingly to remove victims from danger. The first responders are generally required to transport victims that are unable to move on their own. These victims may often be unable to lift themselves off of a floor and be in need of assistance. However, this can be problematic, physically awkward, or even dangerous, particularly if a victim is obese or in a cramped environment with limited maneuvering room. First responders are at risk of receiving back injuries or injuries to other areas of their bodies when lifting and carrying a heavy victim. There is the chance of losing footing while in the process of transporting a victim, putting both the victim and the first responder(s) in danger. The risk of injury is exacerbated over time as first responders continue to subject their bodies to excessive forces while moving heavy victims. In addition to first response situations, it is often necessary to transport people or assist people to move on their own. For example, physical therapy and rehabilitation patients relearning how to walk may require an additional sense of stability and security in the early stages. The gait belt is a common solution that allows transference from one position to another. However, gait belts are not effective when a patient is in the process of falling and in need of assistance to stop the fall. A gait belt does not account for a patient's legs as the belt wraps around the patient's chest only. This results in the belt slipping up to the patient's chest during the fall and failing to stop the fall. The present invention seeks to address the aforementioned issues and provide first responders and caretakers with an effective and safe solution.

The present invention is a harness for lifting, supporting, and maneuvering a person in an ergonomic and safe manner. In its preferred embodiment, the present invention comprises a harness with an adjustable waist belt, a plurality of handles, and two leg straps. The waist belt and leg straps are adjustable by means of three double D-ring mechanisms located on the harness. The handles are located around the circumference of the waist belt. The harness is worn around a person's waist and the leg straps are slotted into the corresponding double D-ring mechanisms and adjusted to secure the person into the harness. The harness belt is centered on the person's body and is then tightened via double D-ring mechanism along with the leg straps. The harness and the person are then lifted by means of the handles around the circumference of the waist belt. The present invention provides additional leverage for users when lifting, supporting, and maneuvering a person wearing the harness.

The object of the present invention is to provide first responders, caretakers, and other personnel with a safe and ergonomic means of lifting and moving victims and patients, particularly those that are obese or elderly. The present invention is designed to maintain the dignity and well-being of victims/patients while maximizing safety of both the victims/patients and first responders/caretakers/other personnel. The present invention is ergonomic to provide leverage during use and is capable of supporting large amounts of weight to prevent failure during use. The present invention has a wide variety of applications in a wide variety of fields including, but not limited to:
First responders (police officers, firefighters, emergency medical services personnel)
Search and rescue (disaster relief)
Physical therapy
Bariatric patients
Community Emergency Response Teams (CERT)
Hospitals
Care facilities
Military
Cruise ships
Hotels/office buildings

### BRIEF DESCRIPTION OF THE DRAWINGS

FIG. 1 is an isometric view of the harness.

FIG. 2 is a right side view of the harness.

FIG. 3 is a left side view of the harness.

FIG. 4 is a front side view of the harness.

FIG. 5 is a rear side view of the harness.

FIG. 6 is a top side view of the harness.

FIG. 7 is a bottom side view of the harness.

### DETAIL DESCRIPTIONS OF THE INVENTION

All illustrations of the drawings are for the purpose of describing selected versions of the present invention and are not intended to limit the scope of the present invention.

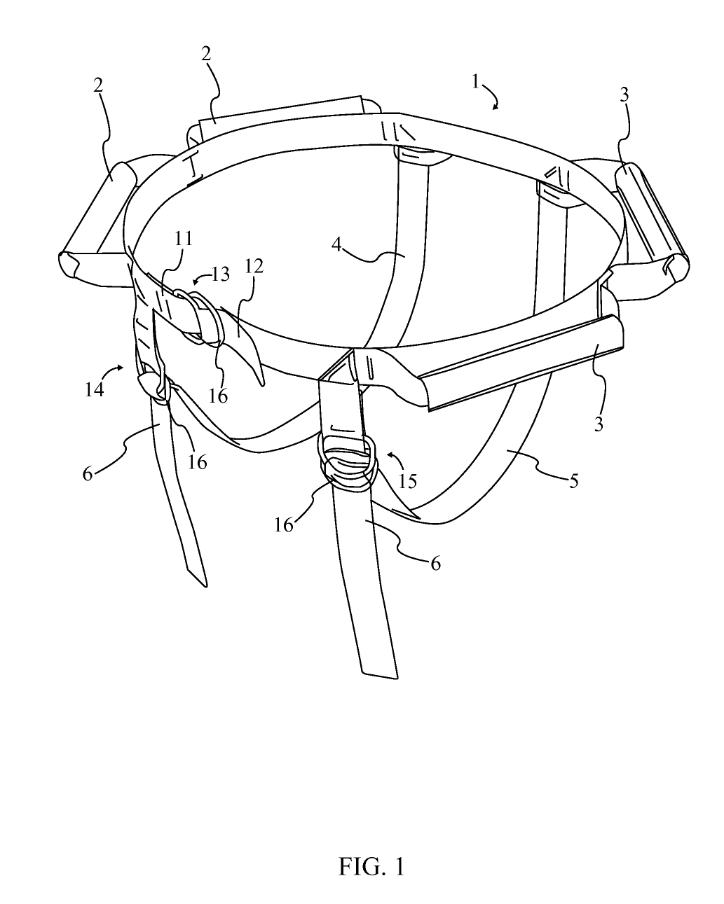

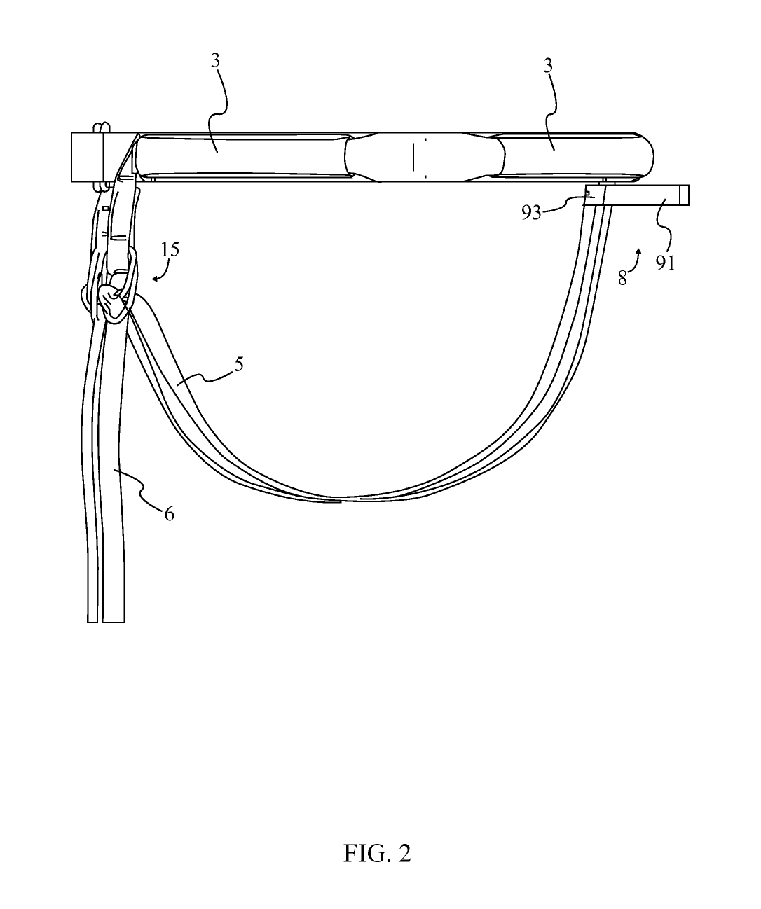

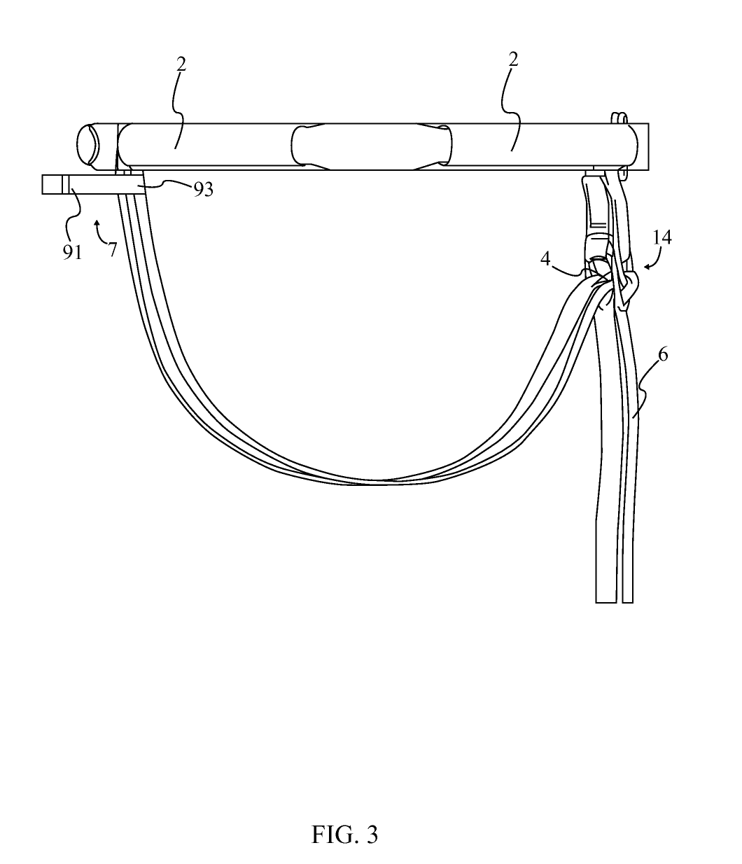

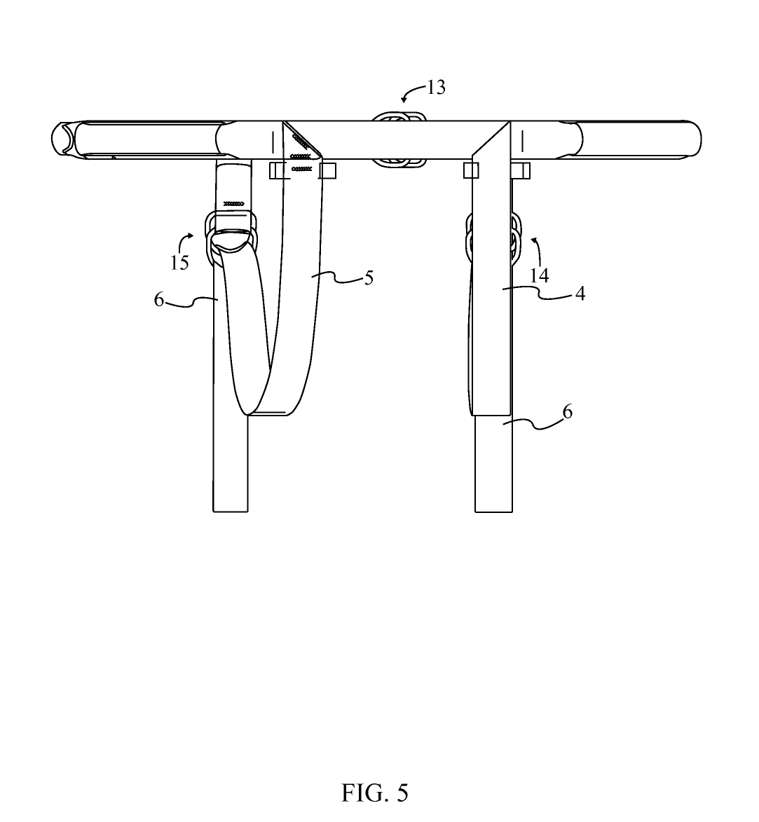

The present invention is an assistant harness for ergonomically and safely lifting, supporting, and maneuvering a person, commonly a patient in an emergency medical situation. The present invention is designed to ensure safety of those attendants who are carrying the patient by means of the present invention while maintaining the dignity and well-being of the patient. To this end the present invention comprises a belt 1, a first plurality of handles 2, a second plurality of handles 3, a first leg strap 4, and a second leg strap 5. The belt 1 is secured around a person's waist while the first plurality of handles 2 and the second plurality of handles 3 are adjacently connected to the belt 1, providing gripping points that allow the present invention to easily be grasped and carried. The first leg strap 4 and the second leg strap 5 are provided for additional support, each being connected to one end of the belt 1 and comprising a free end 6; the free end 6 may be wrapped around a person's thigh and secured to an opposite section of the belt 1, or instead secured out of the way if not needed, e.g. if being used as a gait belt. The first leg strap 4 and the second leg strap 5 each comprise a free end 6 that can be wrapped around a person's leg (in a use configuration) or kept folded next to the belt 1 (in a non-use configuration). The present invention can thus be used as an enhanced gait belt (i.e. not utilizing the first leg strap 4 and the second leg strap 5) and as a harness (i.e. with the first leg strap 4 and the second leg strap 5 being wrapped around a subject's thighs). The present invention is shown from different angles by means of FIG. 1-FIG. 7.

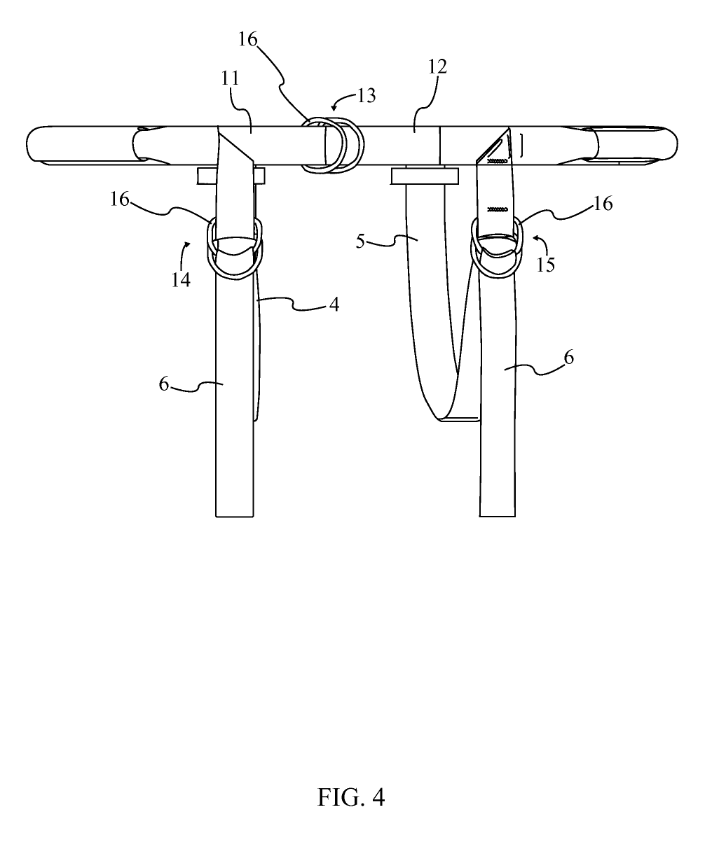

The belt 1 comprises a first end 11, a second end 12, a primary buckle 13, a first auxiliary buckle 14, and a second auxiliary buckle 15. The primary buckle 13 is mounted to the first end 11, serving as a coupling point for the second end 12. An illustration of this coupling is best shown in FIG. 1 and FIG. 4. The first auxiliary buckle 14 and the second auxiliary buckle 15, respectively provided as coupling points for the free end 6 of the first leg strap 4 and the free end 6 of the second leg strap 5, are adjacently connected to the belt 1. The first auxiliary buckle 14 is positioned adjacent to the first end 11, where it is optimally located for coupling the first leg strap 4. Likewise, the second auxiliary buckle 15 is positioned adjacent to the second end 12 in order to better receive and secure the second leg strap 5. These components and their positioning allow the present invention to be used in one of two configurations, either as an enhanced gait belt or as a harness. In the preferred embodiment a pair of D-rings 16 is used for each buckle, with the primary buckle 13 comprising one pair of D-rings 16, the first auxiliary buckle 14 comprising another pair of D-rings 16, and the second auxiliary buckle 15 comprising a last pair of D-rings 16.

While the belt 1 and its associated buckles allow a subject to be supported and even carried (with additional support provided by the first leg strap 4 and the second leg strap 5), the handles improve ergonomics by making the present invention easier to grasp and hold. To evenly distribute the weight of a patient between attendants, the first plurality of handles 2 and the second plurality of handles 3 are positioned opposite each other along the belt 1. Thus, attendants can be positioned on each side of the patient, resulting in better balance when assisting a patient who is using the present invention. More specifically, the first plurality of handles 2 is positioned adjacent to the first end 11 of the belt 1 while the second plurality of handles 3 is positioned adjacent to the second end 12. This positioning is further beneficial as it allows attendants to stand at the side of a patient, allowing the patient to walk or be carried in a forward direction without being obstructed by the attendants. If a different positioning were used for the handles then attendants might be required to carry a patient sideways (or block the patient's walking path if being used as a gait belt).

As earlier referenced, the present invention can be utilized as an enhanced gait belt with the first leg strap 4 and the second lag strap tucked away in a secure position or as a harness with the first leg strap 4 and the second leg strap 5 being wrapped around a patient's thighs. When being utilized as a harness, the first leg strap 4 and the second leg strap 5 are configured such that the first leg strap 4 is engaged with the first auxiliary buckle 14 and the second leg strap 5 is engaged with the second auxiliary buckle 15. This configuration results in the leg straps creating loops (in combination with the belt 1 itself) that is designed to receive a patient's legs.

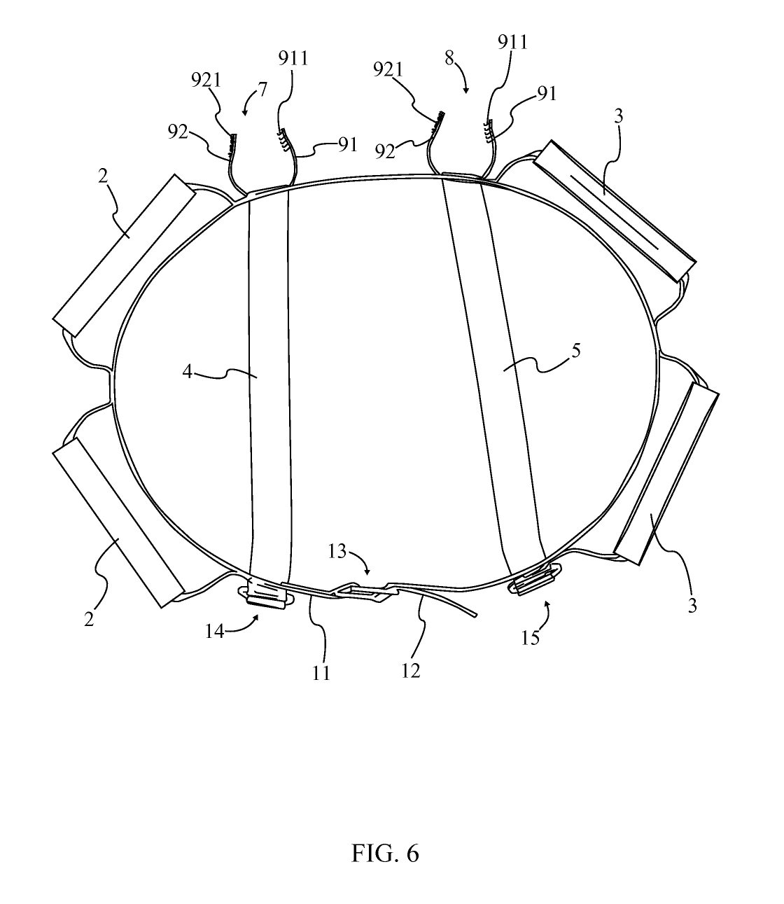

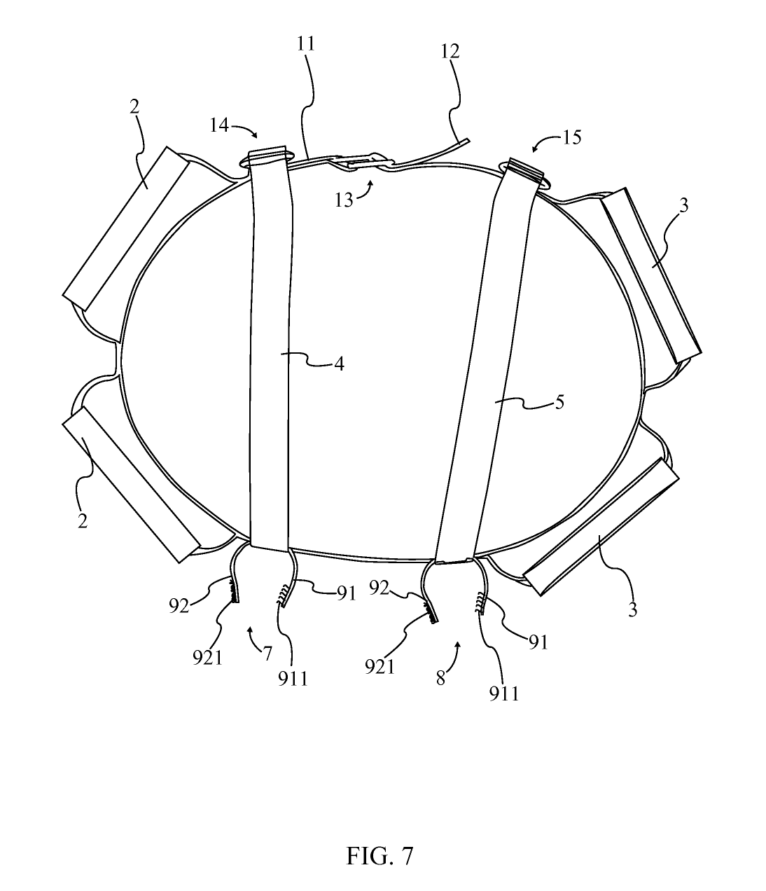

In another configuration in which the present invention is used as a gait belt and the first leg strap 4 and the second leg strap 5 are tucked away, a first restraining strap 7 and a second restraining strap 8 are used to secure the first leg strap 4 and the second leg strap 5. The first restraining strap 7 and the second restraining strap 8 each comprise a fastener portion 91, a receptacle portion 92, and a central portion, with the central portion being adjacently connected to the belt 1. This allows the fastener portion 91 and the receptacle portion 92 to hang loose, such that they be used to restrain a folded (e.g. not in use) leg strap. The restraining straps distinctively shown in FIG. 6 and FIG. 7.

To secure the fastener portion 91 and the receptacle portion 92 to each other, a fastener 911 is positioned on the fastener portion 91 while a receptacle 921 is positioned on the receptacle portion 92. The fastener 911 is engaged with the receptacle 921 in order to secure the fastener portion 91 to the receptacle portion 92. This creates a closed loop that is capable of retaining a folded leg strap, as is desirable when use of the leg straps is unnecessary.

While different embodiments of the present invention may utilize a number of various mechanisms as the fastener 911 and receptacle 921, the preferred embodiment utilizes a hook-and-loop combination for simplicity and low cost. Described in more detail, the fastener 911 is a hook portion of a hook-and-loop fastener 911 while the receptacle 921 is a loop portion of the hook-and-loop fastener 911. Potentially, rather than separating the loop portion and the hook portion, the fastener 911 and the receptacle 921 may each comprise both hook portions and loop portions.

As thus far described the present invention can be used as an enhanced gait belt or a harness. When used as an enhanced gait belt the first leg strap 4 and the second leg strap 5 are tucked away, being folded into themselves and retained by their respective first retaining strap and second retaining strap. To keep the leg straps restrained, the respective fastener 911 is engaged with the corresponding receptacle 921, implemented as a hook-and-loop attachment in the preferred embodiment. The belt 1 itself is wrapped around a patient's waist, with the second end 12 of the belt 1 being engaged with the primary buckle 13, resulting in a secure belt 1 looped about the patient's waist. The first plurality of handles 2 and the second plurality of handles 3 are positioned at the sides of a patient where they are easily accessible to attendants. Attendants are thus able to support a patient by grasping at least one of the handles as the patient walks.

When used as a harness, the fastener 911 and receptacle 921 are disengaged from each other, allowing the free end 6 of the first leg strap 4 to be engaged with the first auxiliary buckle 14 while the free end 6 of the second leg strap 5 is engaged with the second auxiliary buckle 15. The first leg strap 4 and second leg strap 5 are passed along a person's inner thigh, with the pair of straps effectively acting as a seat. The first leg strap 4 and second leg strap 5 thus allow attendants to lift and carry a patient, as may be necessary if the patient has lost all ambulatory capabilities. The handles provide handholds that allow attendants to grab and lift the present invention while making transport easier by distributing the weight amongst available attendants. The combination of the first leg strap 4, the second leg strap 5, the first plurality of handles 2, and the second plurality of handles 3 allow attendants to lift and carry a patient in a dignified and seated matter.

While the preferred embodiment claims a first plurality of handles 2 and a second plurality of handles 3, specific embodiments may utilize different numbers for each plurality of handles, limited only by the available space on the belt 1. In a basic embodiment, the first plurality of handles 2 and second plurality of handles 3 are each formed by a pair of handles, with four handles in total being provided. This configuration allows two attendants to grasp each pair of handles and walk in a sideway manner, or instead allows four attendants to walk in a forward direction, each with one hand holding a single handle.

In a sturdier embodiment provided for heavier patients, there are three individual handles that form each plurality of handles. This may be necessary for overweight patients who require additional attendants to safely be carried via the present invention. Potentially, for even heavier patients (e.g. bariatric), multiple belts 1 may be connected to each other to effectively form a larger sized belt 1. To connected multiple belts 1 in such a manner the second end 12 of one belt 1 is engaged with the primary buckle 13 of an adjacent belt 1, allowing multiple belts 1 to be strained together to accommodate bariatric patients. Not only does this modular configuration allow the weight of bariatric patients to be distributed amongst a greater number of attendants, it also is adapted to the larger waists of bariatric patients which otherwise are so large that a single belt 1 could not be wrapped around them.

Ultimately, the present invention may be provided in a number of varying dimensions to better address population differences in size. For example, the present invention may be built in small, medium, and large sizes that fit the majority of potential customers. This customer oriented design, along with the components and configurations as heretofore described, allow the present invention to be utilized in a wide variety of fields. Examples of possible users, situations, and locations are subsequently described.

First responders, such as police officers, firefighters, and emergency medical services personnel, are one example of a group that may make use of the present invention. Elaborating, in rescue situations victims are often found in difficult to reach positions or areas with limited maneuvering room, creating potential danger for both first responders and victims. Through use of the present invention first responders can quickly and easily assist affected individuals, removing them to areas of safety and towards emergency transport vehicles as necessary. Additionally, by using the first leg strap 4 and the second leg strap 5 of the present invention, first responders can move unconscious or otherwise incapacitated individuals who are incapable of independent movement.

In a similar vein, search and rescue efforts (e.g. as part of disaster relief) can benefit from use of the present invention. After an earthquake or other disasters, search and rescue workers are very likely to encounter collapsed buildings. The resulting rubble creates confined and cramped working conditions that increase the difficulty of rescuing affected individual areas from the rubble. The present invention allows help to be provided to those who can walk, while those who are immobilized can be carried through use of the leg straps.

The present invention can also be applied to physical therapy, where it can be utilized as an auxiliary device that lets physical therapists escort patients. By using the present invention a sense of security can be provided to patients undergoing rehabilitation, especially for difficult tasks such as learning how to walk again.

A field in which the present invention is especially useful is bariatrics, where first responders and caretakers experience an increased risk of injuries to the back and other areas of the body resulting from the increased stress of lifting and transporting bariatric patients. The present invention allows the weight of a bariatric patient to be evenly distributed between multiple attendants, reducing the load and stress experienced by any individual attendant. In extreme cases, multiple copies of the present invention can be secured to each other to accommodate exceptionally large patients. Doing such increases the number of available handles and allows the a patient's weight to be split between a greater number of attendants.

A number of additional examples show how various fields can make use of the present invention. For Community Emergency Response Teams (CERT) the present invention is ideal for personnel that are restricted in the total amount of gear that can be carried. In hospitals, the military, and cruise ships, the present invention can be used to help transport injured patients and persons in general. In care facilities, e.g. private homes, health care facilities, and assisted living facilities, the present invention is useful in aiding tenants that require assistance in standing, moving to shower facilities, and walking in general. Yet another example of potential use is hotels and office buildings, where injured persons may be incapable of using stairs without assistance, and especially so when elevators are unpowered or otherwise unsafe to use.

Although the invention has been explained in relation to its preferred embodiment, it is to be understood that many other possible modifications and variations can be made without departing from the spirit and scope of the invention as hereinafter claimed.

What is claimed is:

1. An assistant harness comprises:
a belt;
a first plurality of handles;
a second plurality of handles;
a first leg strap;
a second leg strap;
the belt comprises a first end, a second end, a primary buckle, a first auxiliary buckle, and a second auxiliary buckle;
the first leg strap and the second leg strap each comprise a free end;
the primary buckle being mounted to the first end;
the first auxiliary buckle and the second auxiliary buckle being adjacently connected to the belt;
the first auxiliary buckle being positioned adjacent to the first end;
the second auxiliary buckle being positioned adjacent to the second end;
the second end being engaged with the primary buckle;
the first plurality of handles and the second plurality of handles each being adjacently connected to the belt;
the first plurality of handles and the second plurality of handles each being positioned along the belt;
the first leg strap and the second leg strap being adjacently connected to the belt; and
the first leg strap and the second leg strap being positioned between the first end and the second end.

2. The assistant harness as claimed in claim 1 comprises:
the first plurality of handles and the second plurality of handles being positioned opposite each other along the belt;
the first plurality of handles being positioned adjacent to the first end; and
the second plurality of handles being positioned adjacent to the second end.

3. The assistant harness as claimed in claim 1 comprises:
the free end of the first leg strap being engaged with the first auxiliary buckle; and
the free end of the second leg strap being engaged with the second auxiliary buckle.

4. The assistant harness as claimed in claim 1 comprises:
the primary buckle, the first auxiliary buckle, and the second auxiliary buckle each comprise a pair of D-rings.

5. The assistant harness as claimed in claim 1 comprises:
a first restraining strap;
a second restraining strap;
the first restraining flap and the second restraining flap each comprise a fastener portion, a receptacle portion, and a central portion;
the central portion being adjacently connected to the belt;
the first restraining strap being positioned adjacent to the first leg strap; and
the second restraining strap being positioned adjacent to the second leg strap.

6. The assistant harness as claimed in claim 5 comprises:
the central portion being positioned between the fastener portion and the receptacle portion;
a fastener being positioned on the fastener portion;
a receptacle being positioned on the receptacle portion; and
the fastener being engaged with the fastener receptacle.

7. The assistant harness as claimed in claim 6 comprises:
the fastener being a hook portion of a hook-and-loop attachment; and
the receptacle being a loop portion of the hook-and-loop attachment.

8. An assistant harness comprises:
a belt;
a first plurality of handles;
a second plurality of handles;
a first leg strap;
a second leg strap;
a first restraining strap;
a second restraining strap;
the belt comprises a first end, a second end, a primary buckle, a first auxiliary buckle, and a second auxiliary buckle;
the first leg strap and the second leg strap each comprise a free end;
the first restraining flap and the second restraining flap each comprise a fastener portion, a receptacle portion, and a central portion;
the primary buckle being mounted to the first end;
the first auxiliary buckle and the second auxiliary buckle being adjacently connected to the belt;
the first auxiliary buckle being positioned adjacent to the first end;
the second auxiliary buckle being positioned adjacent to the second end;
the second end being engaged with the primary buckle;
the first plurality of handles and the second plurality of handles each being adjacently connected to the belt;
the first plurality of handles and the second plurality of handles each being positioned along the belt;
the first leg strap and the second leg strap being adjacently connected to the belt;
the first leg strap and the second leg strap being positioned between the first end and the second end; and
the central portion being adjacently connected to the belt.

9. The assistant harness as claimed in claim 8 comprises:
the first plurality of handles and the second plurality of handles being positioned opposite each other along the belt;
the first plurality of handles being positioned adjacent to the first end; and
the second plurality of handles being positioned adjacent to the second end.

10. The assistant harness as claimed in claim 8 comprises:
the free end of the first leg strap being engaged with the first auxiliary buckle; and
the free end of the second leg strap being engaged with the second auxiliary buckle.

11. The assistant harness as claimed in claim 8 comprises:
the primary buckle, the first auxiliary buckle, and the second auxiliary buckle each comprise a pair of D-rings.

12. The assistant harness as claimed in claim 8 comprises:
the first restraining strap being positioned adjacent to the first leg strap; and
the second restraining strap being positioned adjacent to the second leg strap.

13. The assistant harness as claimed in claim 8 comprises:
the central portion being positioned between the fastener portion and the receptacle portion;
a fastener being positioned on the fastener portion;
a receptacle being positioned on the receptacle portion; and
the fastener being engaged with the fastener receptacle.

14. The assistant harness as claimed in claim 13 comprises:
the fastener being a hook portion of a hook-and-loop attachment; and
the receptacle being a loop portion of the hook-and-loop attachment.

15. An assistant harness comprises:
a belt;
a first plurality of handles;
a second plurality of handles;
a first leg strap;
a second leg strap;
a first restraining strap;
a second restraining strap;
the belt comprises a first end, a second end, a primary buckle, a first auxiliary buckle, and a second auxiliary buckle;
the first leg strap and the second leg strap each comprise a free end;
the first restraining flap and the second restraining flap each comprise a fastener portion, a receptacle portion, and a central portion;
the primary buckle being mounted to the first end;
the first auxiliary buckle and the second auxiliary buckle being adjacently connected to the belt;
the first auxiliary buckle being positioned adjacent to the first end;
the second auxiliary buckle being positioned adjacent to the second end;
the second end being engaged with the primary buckle;
the first plurality of handles and the second plurality of handles each being adjacently connected to the belt;
the first plurality of handles and the second plurality of handles each being positioned along the belt;
the first plurality of handles and the second plurality of handles being positioned opposite each other along the belt;
the first plurality of handles being positioned adjacent to the first end;
the second plurality of handles being positioned adjacent to the second end;
the first leg strap and the second leg strap being adjacently connected to the belt;
the first leg strap and the second leg strap being positioned between the first end and the second end;
a fastener being positioned on the fastener portion;
a receptacle being positioned on the receptacle portion; and
the central portion being adjacently connected to the belt.

16. The assistant harness as claimed in claim 15 comprises:
the free end of the first leg strap being engaged with the first auxiliary buckle; and
the free end of the second leg strap being engaged with the second auxiliary buckle.

17. The assistant harness as claimed in claim 15 comprises:
the primary buckle, the first auxiliary buckle, and the second auxiliary buckle each comprise a pair of D-rings.

18. The assistant harness as claimed in claim 15 comprises:
the first restraining strap being positioned adjacent to the first leg strap; and
the second restraining strap being positioned adjacent to the second leg strap.

19. The assistant harness as claimed in claim 15 comprises:
the central portion being positioned between the fastener portion and the receptacle portion; and
the fastener being engaged with the fastener receptacle.

20. The assistant harness as claimed in claim 15 comprises:
the fastener being a hook portion of a hook-and-loop attachment; and
the receptacle being a loop portion of the hook-and-loop attachment.
